(19) United States
(12) Patent Application Publication
(10) Pub. No.: US 2010/0311564 A1
(43) Pub. Date: Dec. 9, 2010

(54) Dielectric Oxide Films and Method for Making Same

(76) Inventors: Mark Phillps, Albuquerque, NM (US); Travis Thoms, Bosque Farms, NM (US); Saul Ferguson, Albuquerque, NM (US)

Correspondence Address: BERLINER & ASSOCIATES, 555 WEST FIFTH STREET, 31ST FLOOR, LOS ANGELES, CA, 90013, US

(21) Appl. No.: 12/730,151

(22) Filed: Mar. 23, 2010

Related U.S. Application Data
(60) Provisional application No. 61/162,549, filed on Mar. 23, 2009.

(51) Int. Cl. C04B 35/468; C01G 23/047; C04B 35/462; C01G 35/00; C01G 23/04; B05D 5/12; C04B 35/01

(52) U.S. Cl. 501/138; 423/610; 501/134; 423/594.17; 423/598; 427/126.3; 264/104; 977/773

(57) ABSTRACT

Dielectric oxide materials prepared by producing a sol from a mixture of a metal oxide precursor, a solvent, and an epoxide, and preparing a metal oxide material from the sol. In various versions, the mixture can also include a cosolvent, one or more additional metal oxide precursors, water, or a precursor to a glassforming oxide, or any combination thereof. The prepared dielectric oxide materials can be in the form of thin films having high κ values, low electrical leakage, and low dielectric loss tangent values.

### CROSS-REFERENCE TO RELATED APPLICATIONS

This application claims the benefit of U.S. provisional patent Application Ser. No. 61/162,549, filed on Mar. 23, 2009, which is incorporated by reference herein.

### BACKGROUND

1. Field of the Invention

This invention relates generally to dielectric oxide materials.

2. Related Art

Integrated circuits with greater capacity in the same or smaller footprint are being developed. In such circuits, transistor drive current can be increased by using high dielectric constant films to produce gate oxide insulators with higher capacitance.

### BRIEF SUMMARY

A new family of dielectric oxides and a new process for making these oxides via a solution chemistry route are provided. The process is applicable to making these materials in bulk objects or as films or fibers. The materials will find immediate application as thin (<10 μm) films, which can be used in applications where a moderate or high dielectric constant (κ>10) is desired, or where a high refractive index or a moderate index combined with low dispersion is desired.

In one aspect, a method of making a metal oxide material is provided. The method includes a) producing a sol from a mixture that includes an epoxide, a precursor to a metal oxide, and a solvent, and b) preparing a metal oxide material from the sol. The precursor can be a precursor to an oxide of any transition metal ion including a d⁰ transition metal ion, and in particular embodiments, the precursor is a precursor to an oxide of Ti(IV), Zr(IV), Hf(IV), Nb(V), or Ta(V). The precursor may be an alkoxide of the desired metal, or a metal salt, or a metal ion combined with an inorganic or organic ligand. The mixture can further include one or more precursors to one or more additional metal oxides, also known as “modifiers”. In various embodiments, the one or more additional metal oxides (or modifiers) can be an oxide of a divalent metal ion (such as Sr, Ba, Zn or Pb); a monovalent ion (such as Li, Na, Cs or Tl); a trivalent ion (such as Al, Bi or Ce); or a tetravalent ion (such as Sn(IV), Th(IV), Ce(IV), or U(IV)); or any combination thereof. The precursor to the modifier can be an alkoxide of the desired metal, or a metal salt, or a metal ion combined with an inorganic or organic ligand. With or without the precursors to the additional metal oxides, the mixture can also include a cosolvent, water, or a precursor to a glassforming oxide, or any combination thereof. Thus, in any embodiment comprising an epoxide, metal oxide precursor and solvent, the mixture can also include at least one modifier, a cosolvent, water, or a precursor to a glassforming oxide, or any combination thereof. In particular embodiments, the glassforming oxide precursor can be an inorganic glassforming oxide precursor, or an organic glassforming oxide precursor. In certain embodiments, the glassforming oxide is SiO₂, B₂O₃, P₂O₅, GeO₂, As₂O₃, or TeO₂.

In particular embodiments, the precursor to the metal oxide can be titanium isopropoxide, tantalum ethoxide, zirconium n-propoxide, niobium ethoxide, hafnium ethoxide, or another salt or chelate or alkoxide of Ti, Nb, Ta, Hf, or Zr. In any embodiment that includes a precursor to a glass forming oxide, examples of the glass forming oxide precursor include, but are not limited to: a) H₃BO₃ or triethyl borate, for the oxide B₂O₃; tetraethyl orthosilicate or another silicate ester, for the oxide SiO₂; H₃PO₄ for the oxide P₂O₅; germanium isopropoxide or another Ge(IV) ester, for the oxide GeO₂; H₃AsO₄ for the oxide As₂O₅; AsCl₃ for the oxide As₂O₃; and tellurium ethoxide or TeBr₄, for the oxide TeO₂.

The metal oxide material can be prepared from the sol in various embodiments by drying the sol to produce a film, then baking the film, annealing the film, or both baking and annealing the film. In some embodiments, the annealing can involve the use of a laser to heat the film.

In various aspects, the method can provide: a metal oxide or a mixture of metal and nonmetal oxides comprising a glassy phase; a metal oxide material that includes nano-scale grains of crystalline oxide surrounded by a glassy phase, which in particular embodiments can be a paraelectric glassy phase; the surrounding glassy phase that comprises a metal oxide or mixture of metal and nonmetal oxides forming a material having a dielectric constant κ of 10 or greater to as high as 300, or any value or range of values in between—the actual κ value is application dependent, for example, a storage capacitor could have a κ value of 300 while a transparent gate oxide may only have a κ value of 10; a metal oxide material having a refractive index n in the range of from about 1.45 to about 2.6, or any value or range of values in between; or any combination thereof.

Also, the method can provide a metal oxide material that is ferroelectric, magnetic or multiferroic.

In various embodiments, the metal oxide material can be in the form of a thin layer film, a paste, a monolith, or a fiber. In addition, in various embodiments the metal oxide material can be prepared by spin-, dip-, roll-, draw-, or spray-coating; or by means of a printing technique; or by casting a monolith; or by drawing fibers.

In particular embodiments, the metal oxide material comprises an oxide of: Ti(IV), Zr(IV), Hf(IV), Nb(V), Ta(V); a divalent metal ion (such as Sr, Ba, or Pb); a monovalent ion (such as Li, Na, or Tl); a trivalent ion (such as Al, Ce or Bi); or a combination thereof.

In another aspect, a sol prepared by any of the methods described herein is provided. Also provided is any dried film produced from the sol by applying the sol to a surface and then drying the applied sol. Any film produced from the dried film by baking the dried film so as to drive off solvent is further provided, as is any annealed film produced from the dried film by annealing the dried film at a temperature in the range of about 250° C. to 800° C. In various embodiments, the annealed film can be amorphous or can be partially crystalline.

In another aspect, any metal oxide material prepared according to the methods described herein is provided.

### BRIEF DESCRIPTION OF THE DRAWINGS

For a more complete understanding of the present invention, reference is now made to the following descriptions taken in conjunction with the accompanying drawings, in which:

FIG. 1 is an I-V plot of a Ta₂O₅:GeO₂ film, where T_{OX}=115 nm, and κ=90;

FIG. 2 is an I-V plot of a PZT:glass film showing superlative leakage characteristics, where oxide thickness is 119 nm, κ=19.4 at 1 MHz, and loss tangent=1.3%;

FIG. 3 is an I-V plot of a Bi₂O₃.ZrO₂.TiO₂.GeO₂ film, with κ=88 at 1 MHz;

FIG. 4 is a graph showing optical dispersion curves for two high n films and one n˜1.5 film with high Abbe number;

FIG. 5 is a graph showing the optical dispersion curve of a high-index film composed of a titanium alkoxide and glycidol, spun and dried at 295° K;

FIG. 6 is a table listing the compositions of films;

FIG. 7 is a table listing additional examples of films and their properties.

### DETAILED DESCRIPTION

In various embodiments, films and other structures in accordance herein generically include metal ions with a d⁰ or d10 electronic configuration in combination with a main group “glassformer” oxide such as SiO₂. For κ>10 materials, these ions can be d⁰ transition metal ions such as Ti(IV), Zr(IV), HMV), Nb(V), and Ta(V) typically found in traditional high κ oxides. These ions are used individually or in combination with one or more modifier ions, which are typically a divalent metal ion such as Sr, Ba, Zn or Pb, but can also be monovalent (e.g., Li, Na, Cs, Tl) or trivalent (e.g., Al, Ce, Bi), or any combination thereof. Metal ions can also be used in combination with main group “glassformer” oxides such as SiO₂, B₂O₃, P₂O₅, GeO₂, As₂O₃, and TeO₂.

In general, the metal ions can be ions of any transition metal. In particular embodiments involving hi-k dielectrics, the metal can be Ti, Zr, Nb, Ta, or Hf.

The modifier ion can be an ion of any alkali metal, alkaline earth metal, lanthanide, actinide, or main group metal (such as, Al, Ga, In, Sn, Sb, Tl, Pb, or Bi).

In some embodiments (e.g., optical films or transparent conducting oxides), it may be advantageous to use a modifier, alone or in combination with other modifiers or glassformer(s), when a transition metal is absent.

Films and other structures can be made via a process that uses a derivative of traditional sol-gel chemistry in which the source of the metal oxide can be a salt or an alkoxides. The principal distinction between the formulation described herein and previously known sol-gel formulations is the inclusion of an epoxide moiety, in some embodiments with a cosolvent that contains the epoxide moiety. This has the effect of creating gel-forming sols from metal salts (which would otherwise reconstitute as solid salts when dried or deposited). Inclusion of the epoxide moiety additionally improves upon traditional sol-gel chemistry by allowing inclusion of higher concentrations of water into formulations that use metal alkoxides without inducing precipitation or excessively rapid gelation. The result is higher quality films that can be spun uniformly onto substrates as large as 300 mm diameter, and thicker films (300 nm-10 um) that are less susceptible to leakage.

In some embodiments, moderate-to-high κ films are synthesized by combining metal ions in ratios similar to those of known high κ phases such as barium titanate, lead zirconate titanate, tantalum oxide, and hafnium oxide. In the absence of a glassformer, sols made as described herein form thin dielectric films with compositions similar or identical to that of the high κ oxides. Such films can have high κ values, but may be electrically leaky and have a high dissipation factor (loss tangent). In combination with a glassformer species, the metal ions can form a glass or a grainy composite having nano-scale grains of crystalline oxide surrounded by a glassy phase. The glassy phase can be described as a paraelectric (PE) film in that it is highly polarizable but not organized into domains, similar to a ferroelectric heated above its Curie temperature. The dielectric constants of the PE glass films can be the same as, less than, or greater than those of the compositionally similar “parent” ferroelectric phase. However, electrical leakage and dielectric loss tangent can be substantially reduced compared with similarly prepared FE films. This is likely due to the lack of grain or domain boundaries around which leakage occurs, and the lack of a coercive field in PE films.

Thin high κ films with reduced leakage and dielectric loss can have application in thin film or multilayer capacitors for energy storage, or decoupling capacitors on-wafer or in the dielectric stack (in CMOS devices), or as gate oxides, particularly in transparent electronics.

In some embodiments, it can be advantageous to combine nanoscale ferroelectric (FE) grains with the glassy phase by suspending these grains in a sol that forms a PE glassy phase upon anneal. Such an aggregate film can combine increased κ from the FE grains with decreased leakage from the improved insulating properties of the glassy phase. This is also the case where the sol is used as a binder for macroscopic FE powders. In the former case the composites may be applied as thin films, e.g., by dip or spin coating. In the latter case a paste results, which may be used for bulk or thick film capacitors, including capacitors embedded in printed wire boards.

In various embodiments, an effective strategy for synthesizing high refractive index (high n) films (or bulk glass) is to combine a d⁰ transition metal ion known for high index (high n) as the oxide (e.g., Ti(IV) or Ta(V)) with a high index glassformer ion such as GeO₂ or TeO₂. The low glass transition temperatures (Tg) typical of TeO₂ glasses render this platform very useful for applications requiring a low anneal or reflow temperature. A heavy metal modifier ion such as Ba²⁺, Tl⁺, and/or Pb²⁺ can additionally stabilize the film, lower Tg, and increase refractive index. Such optical films have applications in digital imaging and telecom components.

An embodiment for making the high κ or high n oxides described herein starts with a sol dispersed in an organic liquid, which is then applied to a substrate and thermally cured. The sol includes the following:
1. A precursor to at least 1 metal oxide. The precursor can be, but is not limited to, a metal alkoxide, salt, or chelate. The only requirement is that the precursor is soluble in the desired solvent (see below).
2. A solvent such as, but not limited to, an alcohol like methanol, or a glycol ether like 2-methoxyethanol. Certain metals benefit from stabilization with carboxylic acids such as acetic acid, or beta-diketonates such as ethyl acetoacetate. In general, the solvent should be compatible with the metal ion(s) in solution and furthermore produce a sol that performs well with the deposition process desired. These characteristics of the solvent are generally determined empirically. Low molecular weight alcohols, ethers, and glycol ethers can be good solvent candidates.
3. An epoxide such as oxirane, propylene oxide, glycidol, or an alkyl glycidyl ether or ester, or another compound containing at least one epoxide group.

The sol may optionally include any combination of the following:
4. A cosolvent, typically with a lower evaporation rate than the solvent in (2). Cosolvents can typically be selected from higher molecular weight glycol ethers such as diglyme or dipropylene glycol monomethyl ether. Other chemistries (e.g., Freons) may be preferred depending on the metal ion that is being stabilized.
5. One or more additional metal oxide precursors (or modifiers), as salts, alkoxides, chelates, or the like.
6. Water, which can be added as liquid H₂O or as water of crystallization if hydrated metal salts are used.
7. A precursor to a nonmetallic glassforming oxide such as SiO₂, B₂O₃, P₂O₅, GeO₂, As₂O₃, or TeO₂.

In some embodiments, all components of the sol recipe are added as liquids. The metal and glassformer oxide precursors may themselves be solids or liquids at ambient temperature; they are nonetheless mixed with an organic solvent prior to being combined with the other ingredients. These ingredients can be combined in an order that is particular to the oxide precursors involved, and examples are provided below.

Once mixed the sol may be deposited onto a substrate by spin-, dip-, roll-, draw-, or spray-coating, or by using a printing technique such as inkjet, gravure, screen, or stencil printing, or by other means known in the art. It is also possible to cast monoliths or draw fibers from the sol. Depending on the pot life of the particular sol, it may be desired to deposit the material immediately, or the material may be stored and used at a later date.

Once deposited, the sol is dried to produce an amorphous film. Drying can occur at ambient temperature or at elevated temperature, typically at a temperature in the range of about 50° C. to 200° C., or any temperature or temperature sub-range falling in such range. Depending on the application the film may also be annealed, typically at a temperature from about 250° C. to 800° C., or any temperature or temperature sub-range falling in such range. The resulting film can be amorphous, partially crystalline, or completely crystalline. In certain applications it is advantageous to have a partially crystalline or amorphous film since such a film may be less susceptible to electrical leakage.

For applications such as gate oxides or decoupling capacitors where very low leakage is needed but the dielectric constant need not be very high (10<κ<300), it may be advantageous to promote the formation of glassy or partially crystalline (opalescent) phases. The role of the glassformer in these formulations is to promote the formation of glassy or opalescent phases and to inhibit the full crystallization of the film upon anneal. Dielectrics made in this fashion using metal oxide and modifier precursors that would otherwise yield ferroelectric phases upon anneal may instead yield glassy or semicrystalline or opalescent paraelectric (PE) phases. These phases may have lower dielectric constants than the analogous ferroelectric phases but can produce thin films with less leakage.

Although nonmetallic glass oxides can be used as the glassformer species as shown by some of the examples below, the methods described herein are not limited to using inorganic oxide precursors. For example, it may be advantageous to use an alkylated precursor such as methyltriethoxysilane to increase pot life, as in Example 13. It may also be advantageous to use hydrogen or methyl silsesquioxanes or silicones as glassformer species to enhance certain mechanical characteristics of the annealed films such as modulus, hardness, and/or flexibility.

Also, the range of epoxides that are useful are not limited to the examples of propylene oxide and glycidol described in the examples. Other epoxides that can be used include, but are not limited to, oxirane, propylene oxide, ethyl oxirane, 1,2 dimethyl oxirane, epichlorohydrin, glycidol, glycidal, glycidyl ethers including glycidyl methyl ether, glycidyl isopropyl ether, diglycidyl ether, ethylene glycol diglycidyl ether, glycidyltriethoxysilane, or other epoxides and derivatives thereof.

In addition, the anneal temperatures used in the examples should not be taken as limiting cases. It is possible with many compositions to use higher annealing temperatures to obtain improved or desired properties, or if shorter anneal times are desired. Lower anneal temperatures are also available, particularly if combined with UV illumination or cathode ray irradiation. This may be particularly useful if dielectric oxide films are to be applied to thermally sensitive substrates such as plastic, copper or steel. Further, atmospheres other than air may be used to improve performance or to prevent damage to the substrate or other components.

Furthermore, with various embodiments, annealing using a laser is effective and useful if the dielectric is to be coated onto a substrate that cannot withstand prolonged high temperatures. The laser should emit a wavelength that either the film or substrate readily absorbs. Typically, the film will absorb UV light between 250 and 350 nm; example laser wavelegths include 355 nm and 266 nm (e.g., from tripled or quadrupled YAG:Nd or YVO₄:Nd lasers). Pulsed CO₂ laser light (10.6 micrometers) will be absorbed by certain substrates causing intense local heating, which in turn causes the film to anneal.

As apparent herein, the synthetic chemistry practice described in the following examples is not limited to d⁰ transition metals and main group oxides. For example, in addition to the previously discussed application of this film synthesis technology for making dielectrics, magnetic oxide materials and films (e.g., ferrites) or multiferroic materials and films can also be made using similar chemistry. Such materials can be made by including ferromagnetic or antiferromagnetic nanoparticles in a PE glassy film matrix. The result is an insulating, moderate-κ film containing regions of high magnetic susceptibility. This could be used in a device in which an external electric field tunes the magnetic resonance of the FM or AF particle, creating a tunable high frequency oscillator or filter. Alternately, an applied magnetic field can create local ordering of the PE glass to form FE domains via strain induced by magnetostriction. This concept can be inverted to make a multiferroic film comprising FE nanoparticles inside a magnetic glass host.

The chemistry described here can also be used to make glass with valuable optical properties such as high index and/or low dispersion.

The process for making glassy PE films can be illustrated with films containing a precursor to a single metal oxide film, with and without a nonmetallic glassformer oxide species. The following examples are intended for illustration purposes only and should not in any sense be construed as limiting the scope of the invention.

### EXAMPLES

### Single Metal Oxide Films

### Example 1

TiO₂ film: 1 g of a 1 mol/L solution of titanium isopropoxide in 1-methoxy-2-propanol was combined with a mixture of 0.5 g each propylene oxide and 2-(2-ethoxy)ethoxyethanol. This sol was then spun onto a Si wafer at 1500 rpm for 1 min. After a soft bake at 140° C. for 5 min., the chip was annealed in air for 30 min. at 400° C. The resulting film was optically slightly hazy, with an oxide thickness (T_{OX}) of approximately 105 nm. The dielectric constant κ at 1 Mhz was 32.7, and the loss τ was 23%.

### Example 2

TiO₂:GeO₂ film: 0.8 g of a 1 mol/L, solution of titanium isopropoxide in 1-methoxy-2-propanol was combined with 0.2 g of a 1 mol/L solution of germanium isopropoxide in 1-methoxy-2-propanol. This solution was combined with a mixture of 0.5 g each propylene oxide and 2-(2-ethoxy)ethoxyethanol. This sol was then spun onto a Si wafer at 1500 rpm for 1 min. After a soft bake at 140° C. for 5 min., the chip was annealed for 30 min. at 400° C. The resulting film was optically clear, with a T_{OX} of approximately 110 nm., κ of 26.1, and loss τ of 16%.

### Example 3

Ta₂O₅ film: 1 g of a 1 mol/L solution of tantalum ethoxide in 2-ethoxyethanol was mixed with 1 g glycidol. After a few minutes, 0.5 g of a 10 mol/L solution of H2O in 1-methoxy-2-propanol was added dropwise with agitation. This sol was then spun onto a Si wafer at 1500 rpm for 1 min. After a soft bake at 140° C. for 5 min., the chip was annealed for 60 min. at 600° C. The resulting film was optically slightly hazy, with a T_{OX} of approx. 160 nm. The dielectric constant κ at 1 Mhz was 23, and the loss τ was 25%.

### Example 4

Ta₂O₅:GeO₂ film: 1 g of a 1 mol/L solution of tantalum (V) ethoxide in 2-ethoxyethanol was combined with 0.2 g of a 1 mol/L solution of germanium isopropoxide in 1-methoxy-2-propanol and 1 g glycidol. After a few minutes, 0.5 g of a 10 mol/L solution of H₂O in 1-methoxy-2-propanol was added dropwise with agitation. This sol was then spun onto a Si wafer at 1500 rpm for 1 min. After a soft bake at 140° C. for 5 min., the chip was annealed for 60 min. at 600° C. The resulting film was optically clear, with a T_{OX} of approximately 115 nm. The dielectric constant κ at 1 Mhz was 90, and the loss τ was 25%.

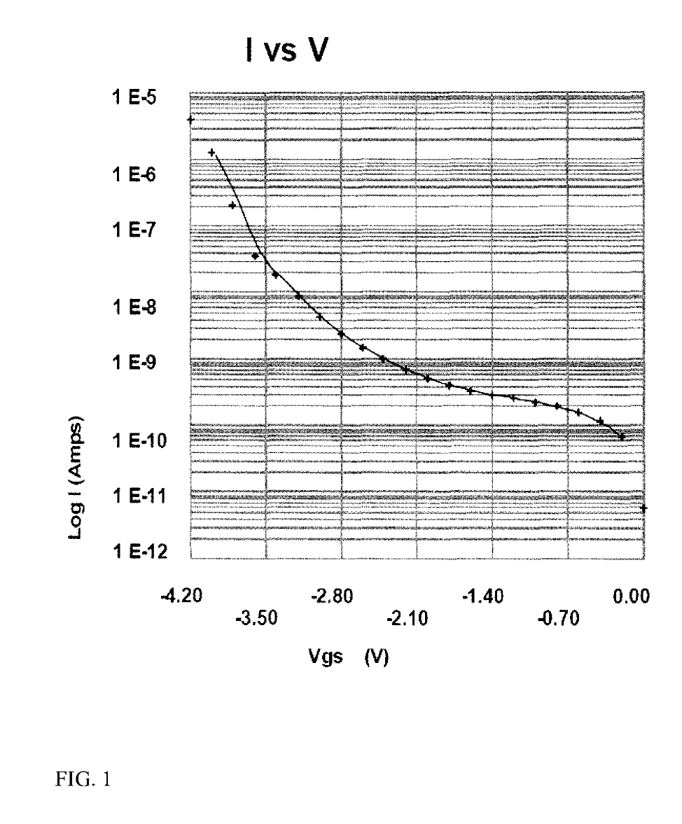

FIG. 1 shows a current vs. voltage (I-V) plot of a resulting Ta₂O₅:GeO₂ film, where T_{OX}=115 nm, and κ=90.

### Multicomponent Metal Oxide Films

Multicomponent metal oxide films further demonstrate the range of the synthetic technique. In each case, adding a glassformer oxide precursor increased κ, decreased loss τ, or reduced electrical leakage, alone or in combination.

### Example 5

PZT (PbO.ZrO₂.TiO₂) film: A solution containing 1 g each 2-(2-ethoxy)ethoxyethanol) and propylene oxide was prepared. To this solution 0.48 g 1 mol/L titanium isopropoxide and 0.52 g 1 mol/L zirconium n-propoxide, both in 1-methoxy-2 propanol, were added. 1 g lead (II) acetate, Pb(OAc)2, 1 mol/L in methanol was added dropwise. This sol was then spun onto a Si wafer at 1500 rpm for 1 min. After a soft bake at 140° C. for 5 min., the chip was annealed for 10 min. at 400° C. The resulting film was optically clear, with a thickness of approximately 110 nm, κ of 25.5, and loss τ of 20%.

### Example 6

PZT:Ge (PbO.ZrO₂.TiO₂.GeO₂) film: A solution containing 1 g each 2-(2-ethoxy)ethoxyethanol) and propylene oxide was prepared. To this solution 0.48 g 1 mol/L titanium isopropoxide, 0.52 g 1 mol/L zirconium n-propoxide, and 0.2 g 1 mol/L germanium isopropoxide, all in 1-methoxy-2 propanol, were added. 1 g lead (II) acetate, Pb(OAc)₂, 1 mol/L in methanol was added dropwise. This sol was then spun onto a Si wafer at 1500 rpm for 1 min. After a soft bake at 140° C. for 5 min., the chip was annealed for 10 min. at 400° C. The resulting film was optically clear, with a thickness of approximately 120 nm. κ was 19.4, and the loss τ was 1.3%.

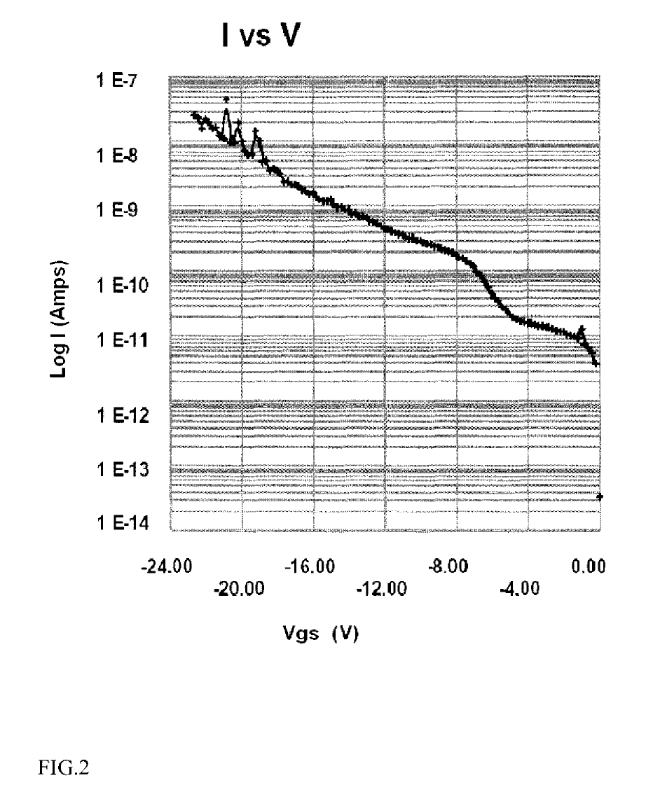

As shown by the I-V plot of FIG. 2, the resulting film displayed relatively low electrical leakage.

### Example 7

Barium titanate (BaO.TiO2) film: A solution containing 0.5 g each 2-(2-ethoxy)ethoxyethanol) and propylene oxide was prepared. To this solution 0.33 g 1 mol/L titanium isopropoxide in 1-methoxy-2 propanol was added, followed by 0.33 g Ba(ClO4)2, 1 mol/L in methanol. 0.05 g 10 mol/L H2O in 1-methoxy-2 propanol was added dropwise with agitation. This sol was then spun onto a Si wafer at 1000 rpm for 1 min. After a soft bake at 140° C. for 5 min., the chip was annealed for 16 hr. at 600° C. The resulting film was optically clear, with a thickness of approximately 110 nm, κ was 16.6 and loss τ of 19%.

### Example 8

BaO.TiO₂.TeO₂ film: A solution containing 0.5 g each 2-(2-ethoxy)ethoxyethanol) and propylene oxide was prepared. To this solution 0.35 g 1 mol/L titanium isopropoxide in 1-methoxy-2 propanol was added. 0.2 g 0.5 mol/L, TeBr₄ in 2-methoxyethanol was added dropwise with agitation, followed by 0.2 g Ba(ClO₄)₂, 1 mol/L in methanol. This sol was then spun onto a Pt-coated Si wafer at 1000 rpm for 1 min. After a soft bake at 140° C. for 5 min., the chip was annealed for 30 min. at 400° C. The resulting film was optically clear, with a thickness of approx. 140 nm. κ was 40, and the loss τ was 1.8%.

### Example 9

BaO.TiO₂.GeO₂ film: 0.7 g 1 mol/L titanium isopropoxide in 1-methoxy-2 propanol was added dropwise to 1 g glycidol. 0.4 g 1 mol/L germanium isopropoxide in 1-methoxy-2-propanol was added dropwise to this solution, which was cooled to 5° C. 0.4 g of a 1 mol/L solution of Ba(ClO₄)₂ in 1-methoxy-2-propanol was added dropwise with agitation. This sol was then spun onto a Si wafer at 1000 rpm for 1 min. After a soft bake at 140° C. for 5 min., the chip was annealed for 10 min. at 400° C. The resulting film was optically clear, with a thickness of approximately 98 nm, κ of 11, and loss τ of 1.8%.

### Example 10

Bi₂O₃.TiO₂.GeO₂ film: 1 g of a 1 mol/L solution of Bi(NO₃)₃ in 1:1 acetic acid/2-ethoxyethanol was added dropwise to 1 g glycidol with agitation. To this solution 1 g 1 mol/L titanium isopropoxide in 1-methoxy-2 propanol was added, followed by 0.2 g 1 mol/L germanium isopropoxide in 1-methoxy-2-propanol. This sol was then spun onto a Si wafer at 1000 rpm for 1 min. After a soft bake at 140° C. for 5 min., the chip was annealed for 10 min. at 600° C. The resulting film was optically clear, with a thickness of approximately 130 nm, κ of 21, and loss τ of 0.8%.

### Example 11

Bi₂O₃.ZrO₂.TiO₂ film: 1 g of a 1 mol/L solution of Bi(NO₃)₃ in acetic acid was added dropwise to 1 g each 2-(2-ethoxy)ethoxyethanol and propylene oxide with agitation. To this solution 0.48 g 1 mol/L titanium isopropoxide and 0.52 g 1 mol/L zirconium n-propoxide, both in 1-methoxy-2 propanol, were added. This sol was then spun onto a Si wafer at 1000 rpm for 1 min. After a soft bake at 140° C. for 5 min., the chip was annealed for 30 min. at 400° C. The resulting film was optically hazy with a thickness of approximately 155 nm, κ of 35.3, and loss τ of 6.3%.

### Example 12

Bi₂O₃.ZrO₂.TiO₂.GeO₂ film: 1 g of a 1 mol/L solution of Bi(NO₃)₃ in 1:1 acetic acid/2-ethoxyethanol was added dropwise to 2 g glycidol with agitation. To this solution 0.48 g 1 mol/L titanium isopropoxide, 0.52 g 1 mol/L zirconium n-propoxide, and 0.2 g germanium isopropoxide, all in 1-methoxy-2 propanol, were added. This sol was then spun onto a Si wafer at 1000 rpm for 1 min. After a soft bake at 140° C. for 5 min., the chip was annealed for 60 min. at 400° C. The resulting film was optically clear with a thickness of approximately 145 nm. κ was 88, and the loss τ was 20%.

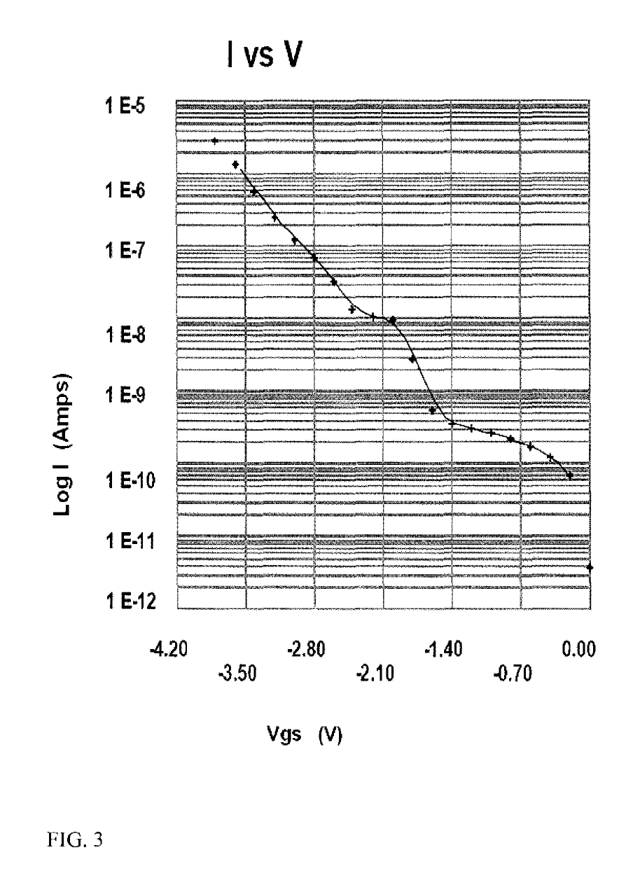

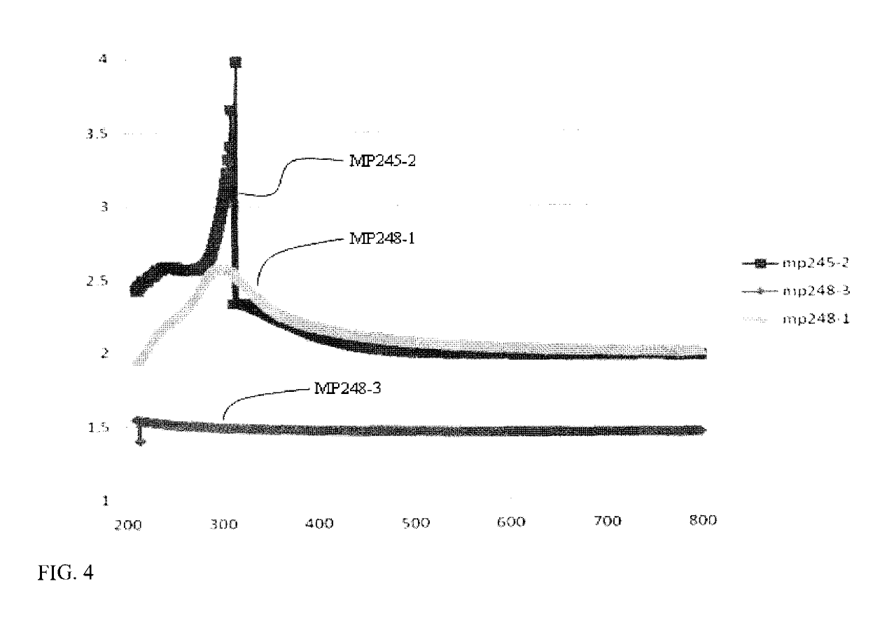

FIG. 3 shows an I-V plot for a resulting Bi₂O₃.ZrO₂.TiO₂.GeO₂ film.

### Example 13

SiO₂.Al₂O₃.ThO₂ film: 1 g of a 1 mol/L solution of Al(NO₃)₃.9H₂O in 2-methoxyethanol was added dropwise to 2 g glycidol with agitation. This was followed by 1 g neat methyltriethoxysilane and 0.5 g of a 1 mol/L Th(NO₃)₄ solution in methanol. This sol was then spun onto a Si wafer at 1000 rpm for 1 min. After a soft bake at 140° C. for 5 min., the chip was annealed in air for 10 min. at 400° C. The resulting film had a T_{OX} of about 570 nm and an Abbe number of 46.5.

### Example 14

FIG. 4 shows optical dispersion curves for three test films made via the synthetic processes described herein. Film mp 245-2 was prepared as in Example 12, above. Film mp 248-1 was made using the process described in Example 8, above, except that it was coated onto a bare Si wafer. Film mp 248-3 was made as in Example 13.

It should be apparent that this technique is applicable to synthesizing any number of optical glass compositions, many of which, like the films shown in FIG. 4 above, are difficult to impossible to prepare using conventional glassmaking methods.

### Example 15

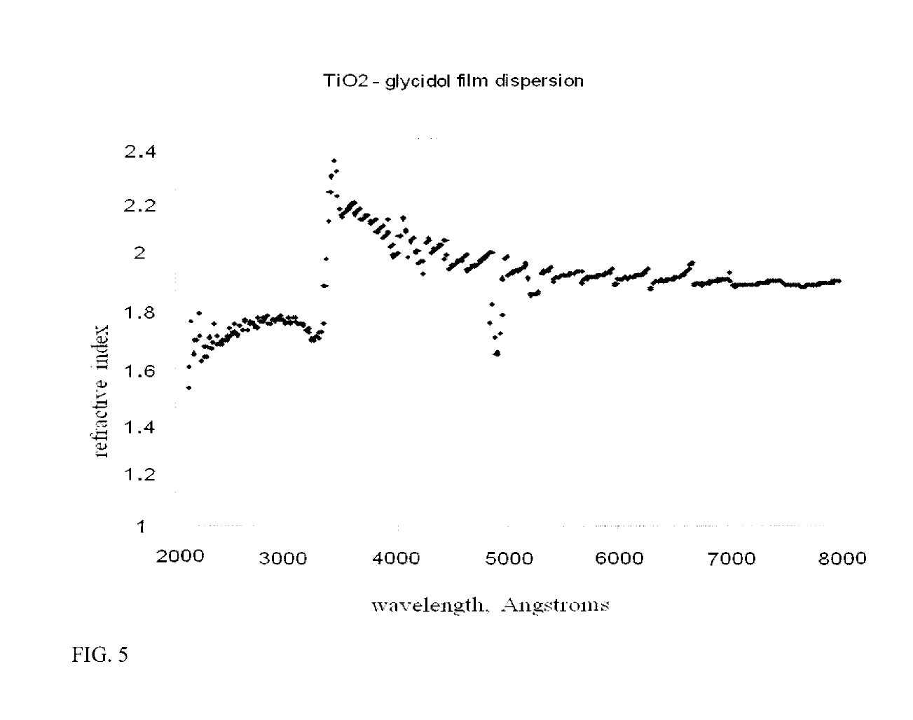

11.7 g titanium isopropoxide (97%) is combined with 1-methoxy-2-propanol to make a solution containing 1.5 mmol Ti per gram of solution. Next, 4.93 g glycidol (96%) is added with stirring, followed by 0.5 g of a solution made by combining 3.6 g H₂O and 16.4 g 1-methoxy-2-propanol. After 1 day, 10 g of the resulting sol is mixed with 4 g 2-(2-ethoxy)ethoxyethanol. This solution may be dispensed via spin, dip, or spray coating to yield a coating that dries to a film about 1-3 μm thick at room temperature. The dispersion curve of this high-index film is shown in FIG. 5.

### Example 16

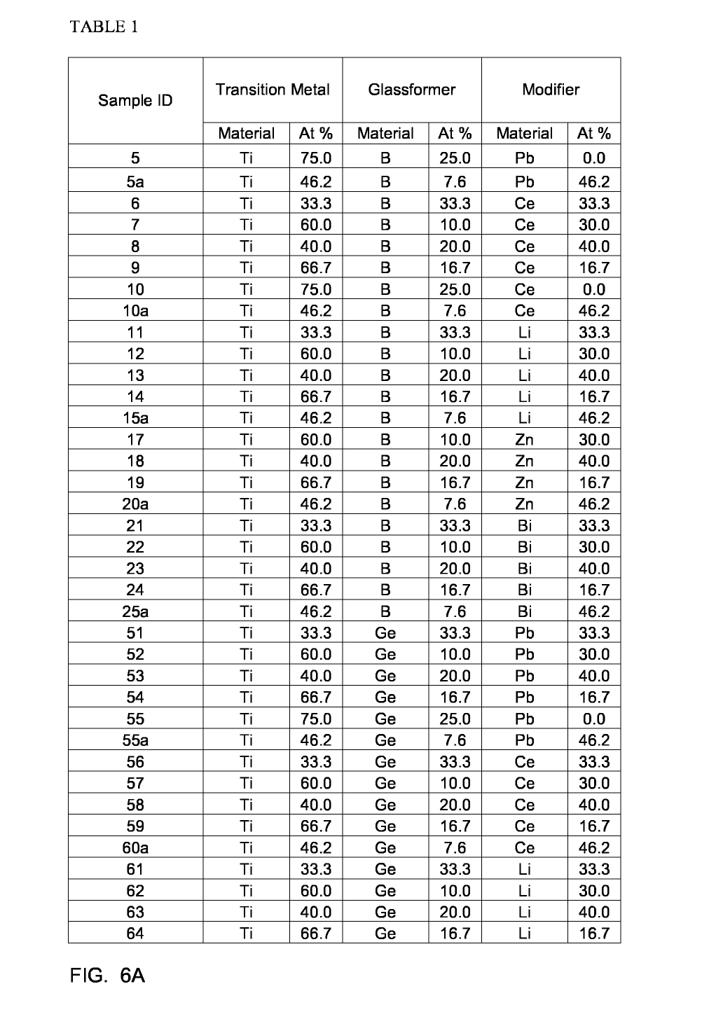

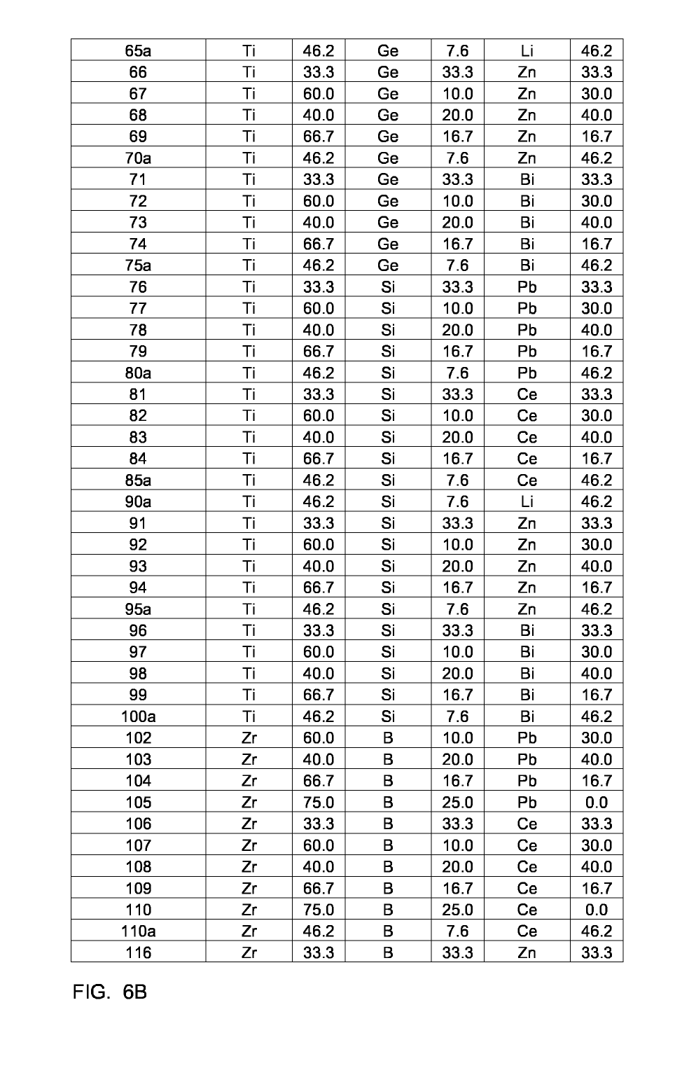

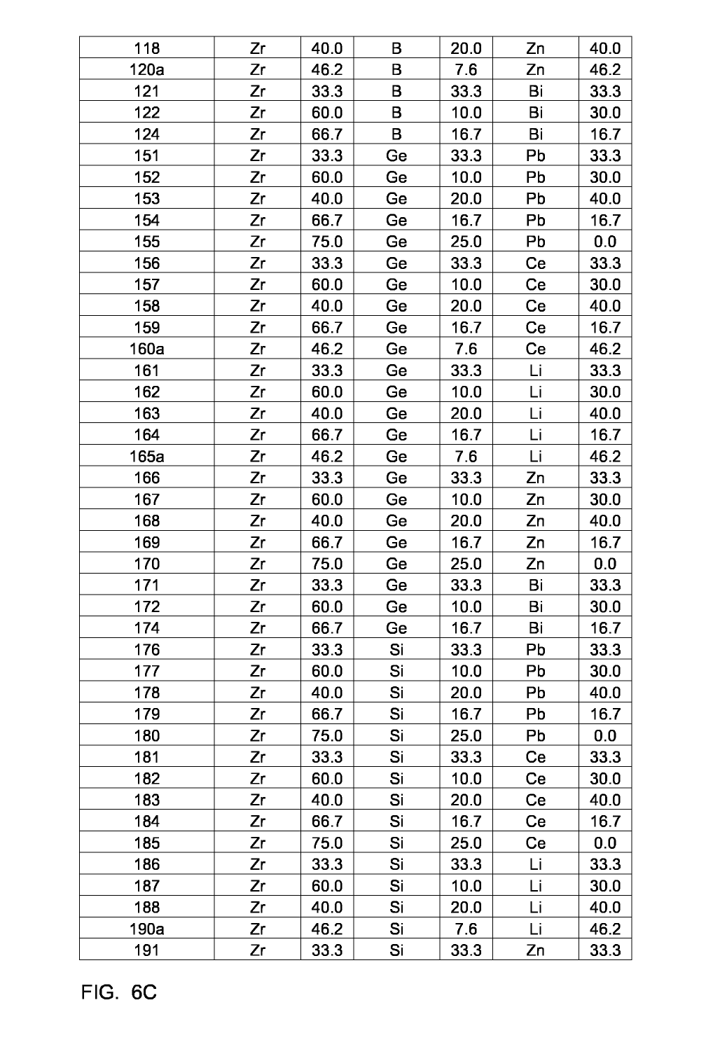

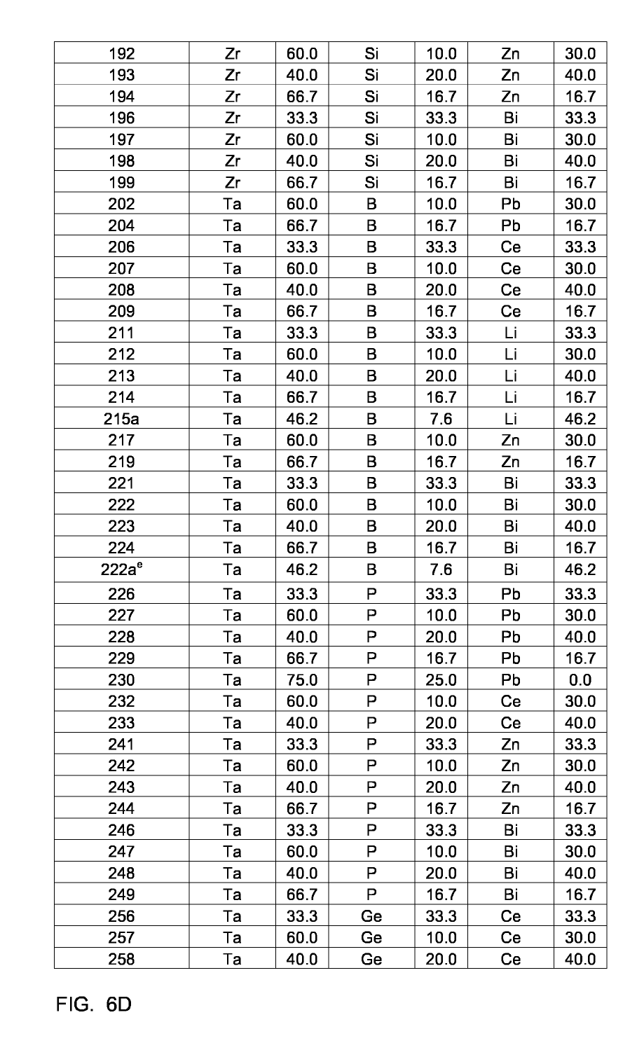

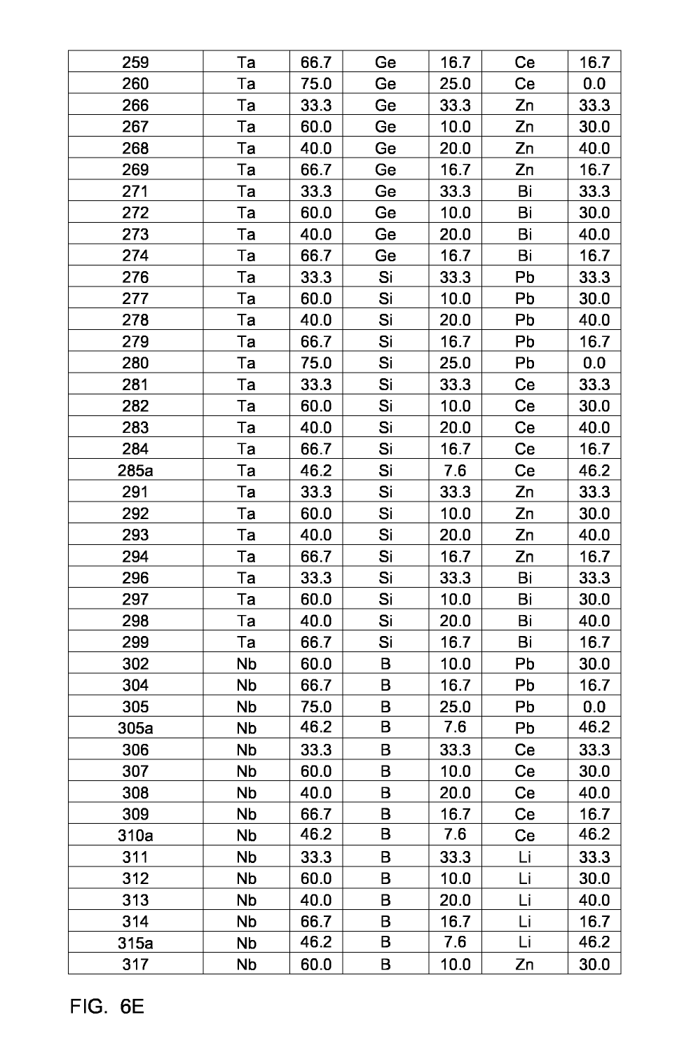

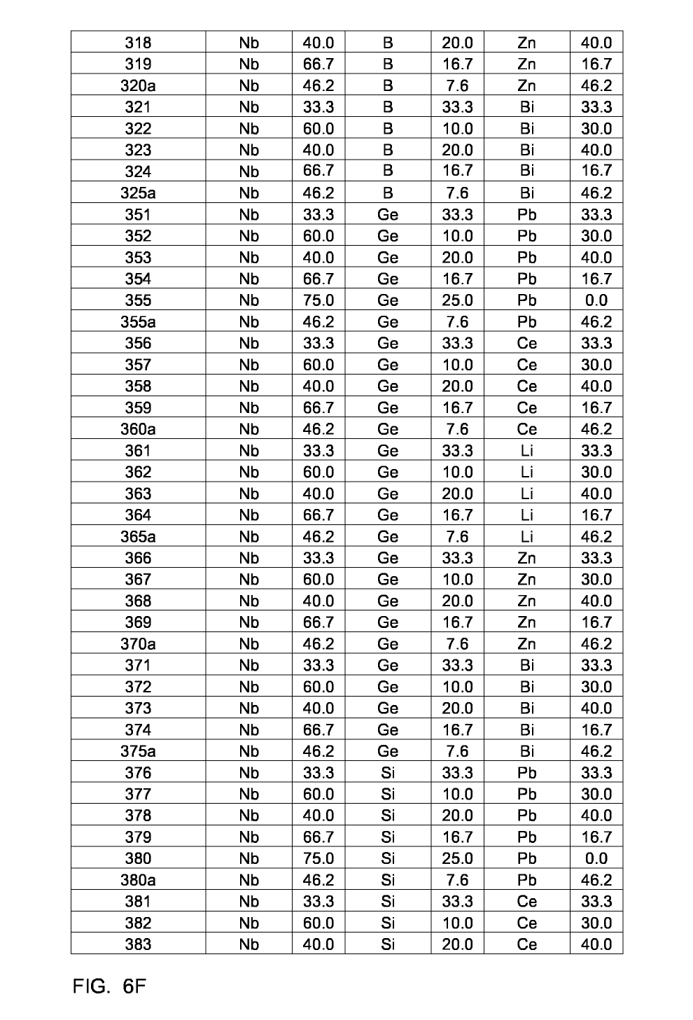

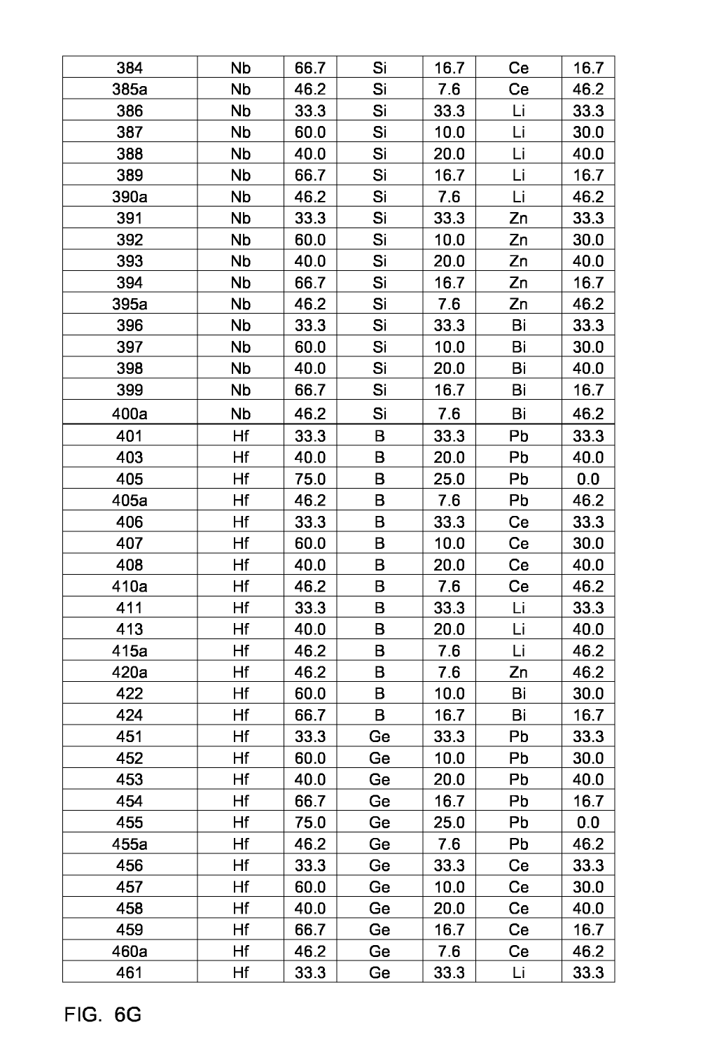

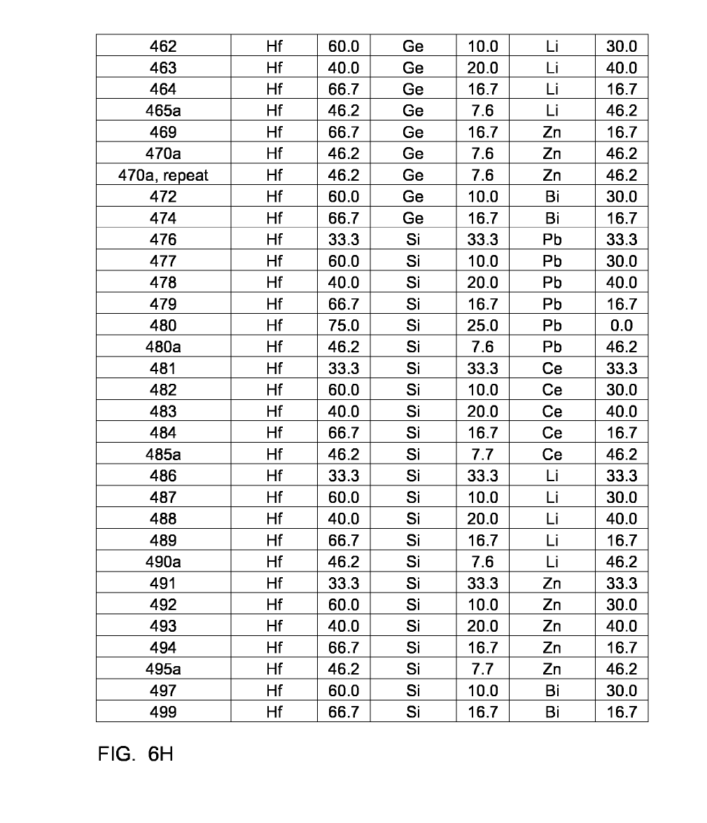

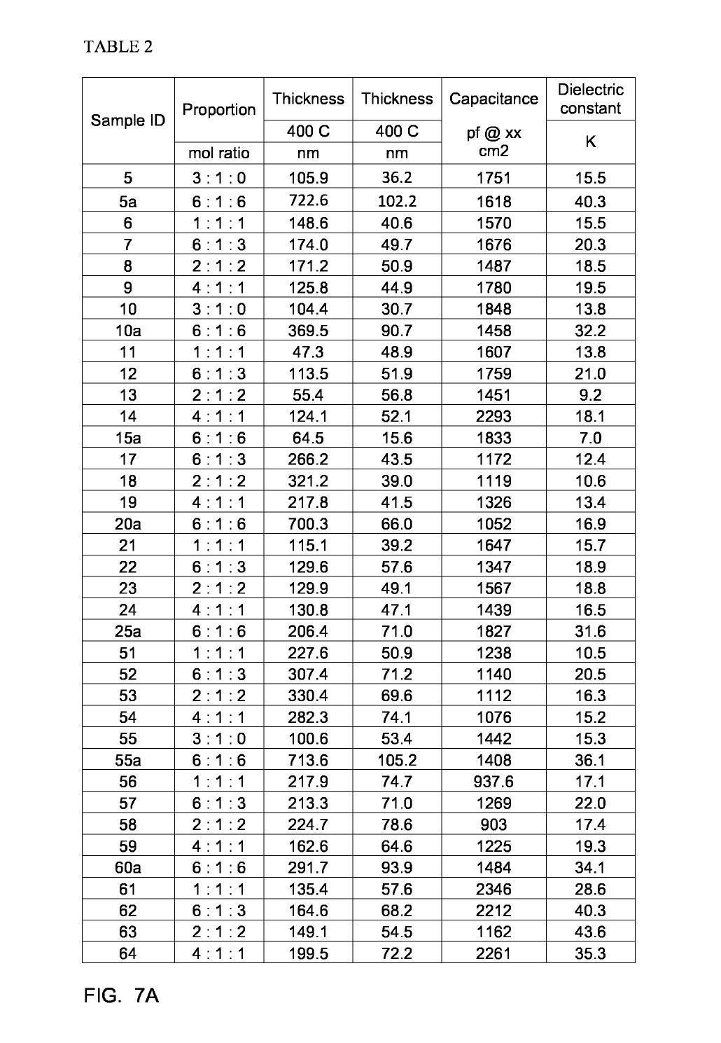

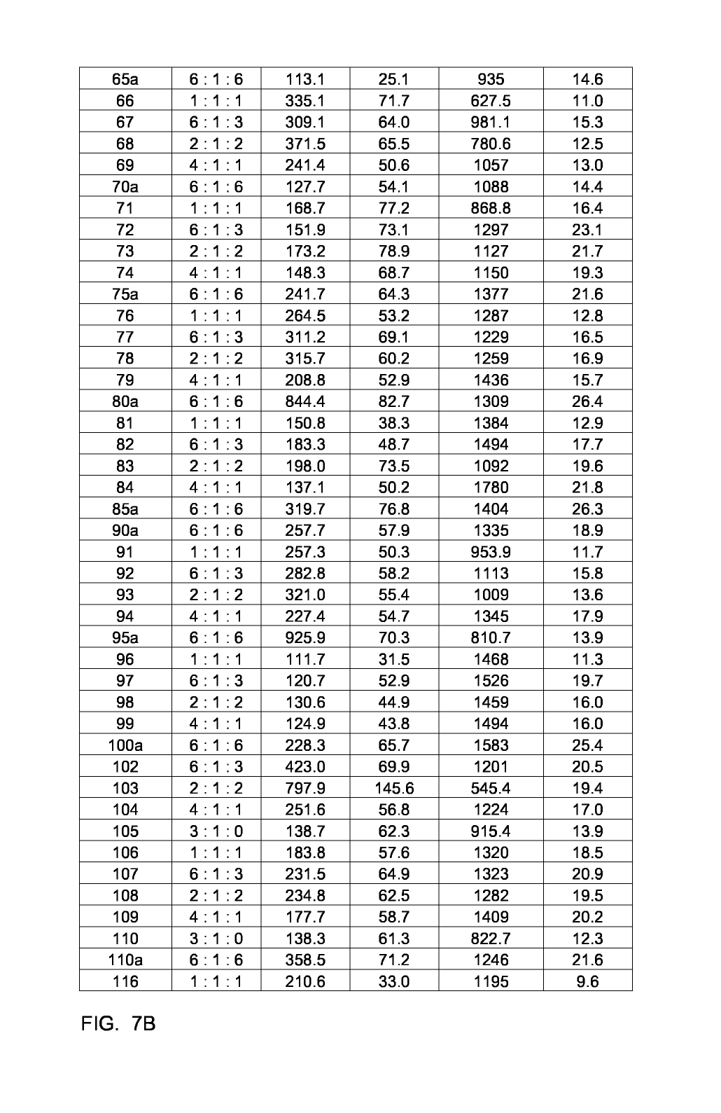

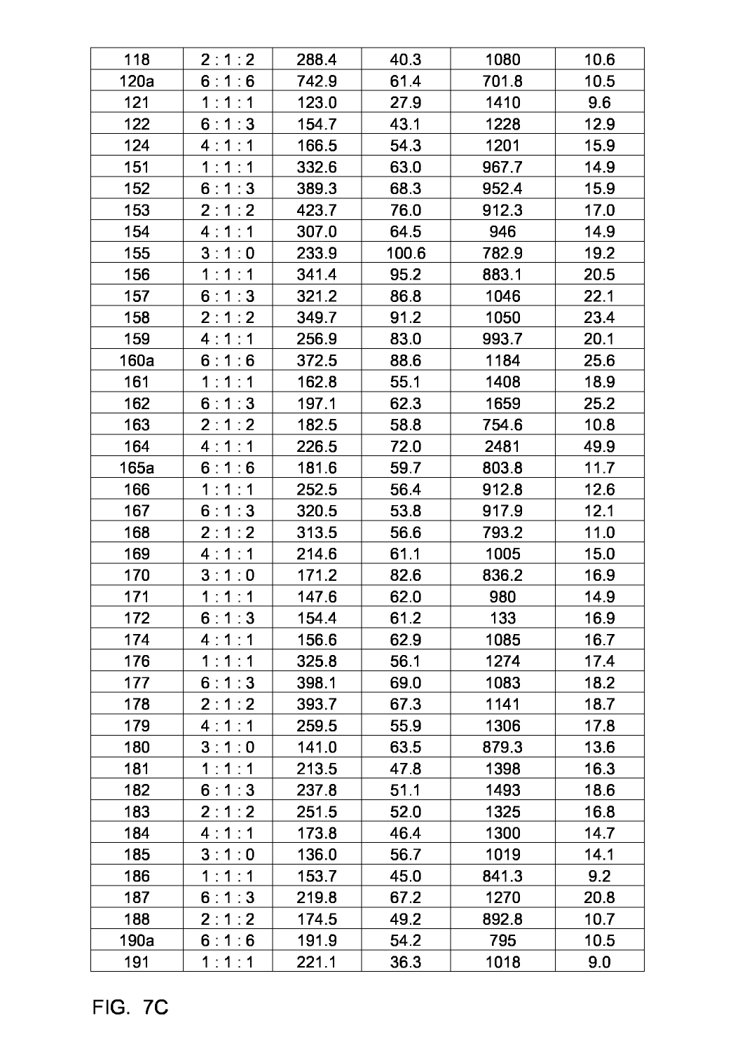

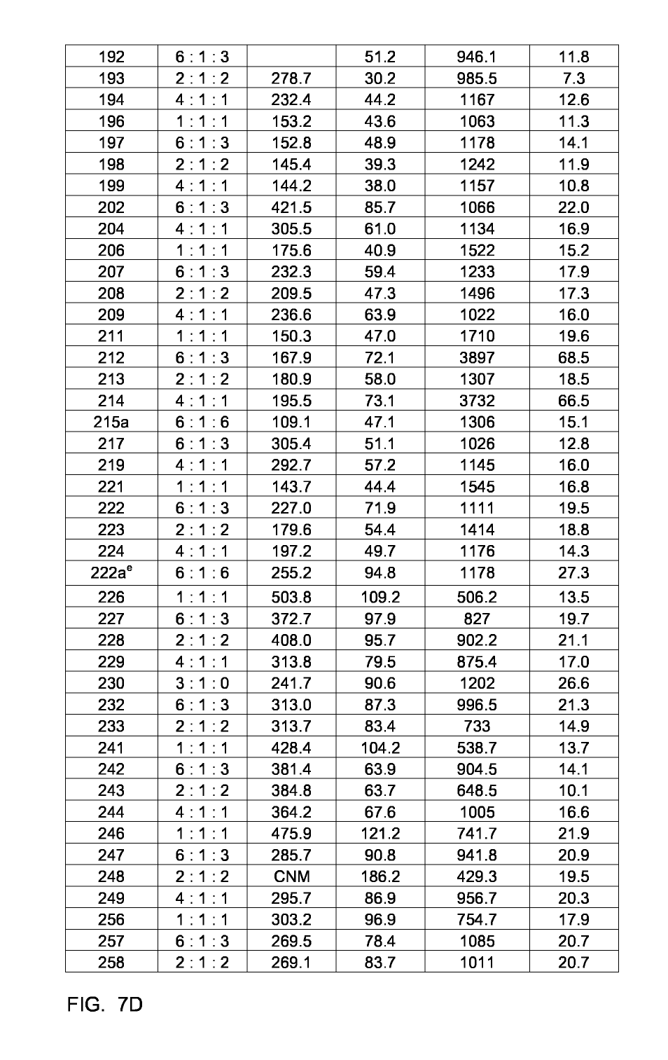

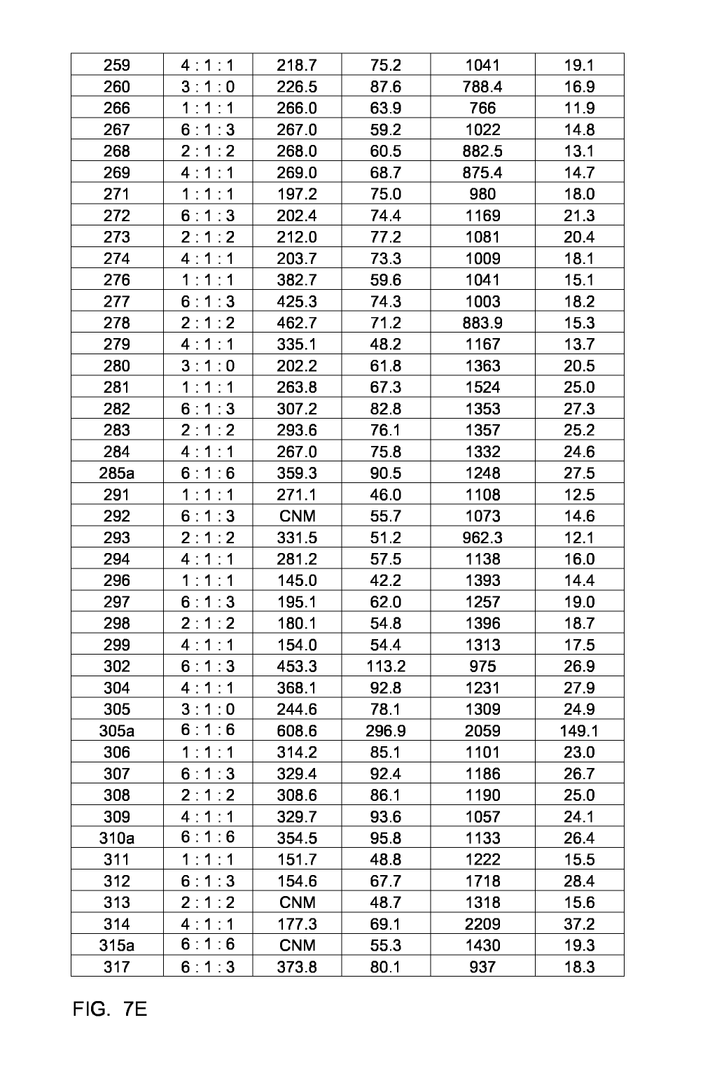

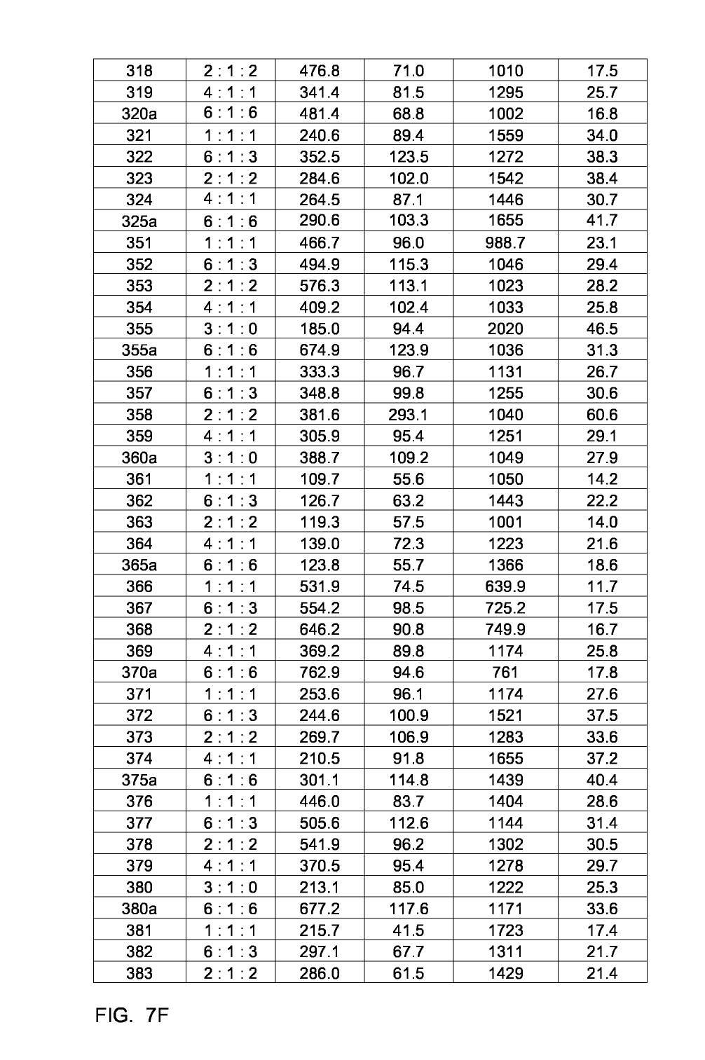

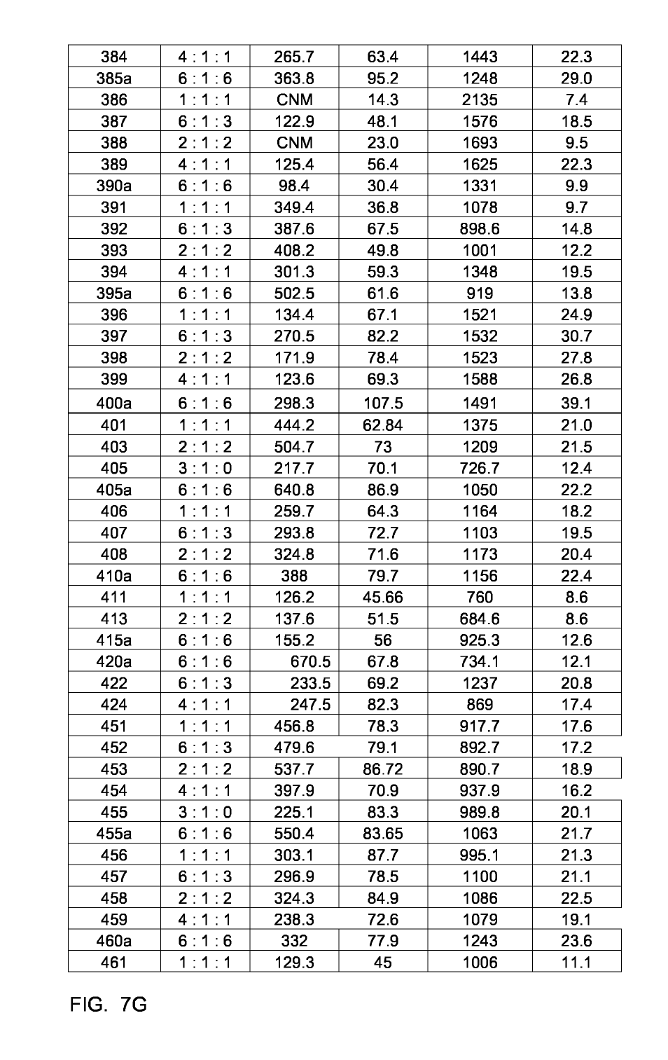

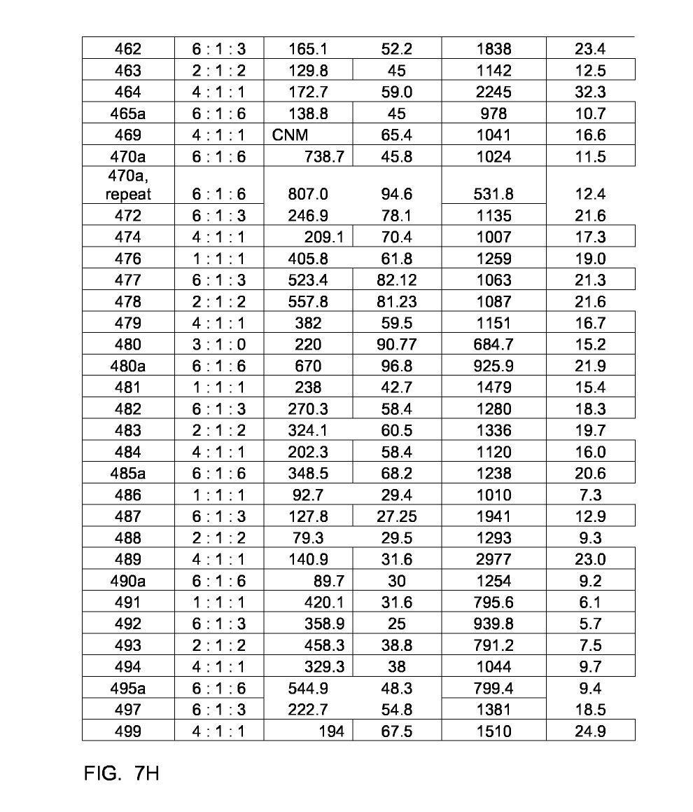

Further examples of high-k dielectric oxide recipes are located in Table 1 (FIG. 6) and Table 2 (FIG. 7). Tables 1 and 2 refer to the same samples. In Table 1, the composition of each sample is defined by the atomic percents of the constituent oxide precursors with respect to the other oxide constituents. For example, sample 8 contains 40% Ti, 20% B, and 40% Ce, so that the final mole ratio in the oxide film after anneal would be 4 TiO₂: 1 B₂O₃: 2 Ce₂O₃. The atomic percents do not reflect other added components such as epoxide, solvent, or water.

All samples in this example contained 1-methoxy-2-propanol as a solvent, 2,2-(ethoxy)ethoxyethanol as a cosolvent, and glycidyl isopropyl ether as the epoxide. Sols containing Li or Bi also contained acetic acid.

All films were deposited by spin-coating at 1000 rpm for 90 s. Films were then soft-baked at 130° C. for 10 minutes, then annealed in air at 400° C. for 30 minutes.

The precursors used for various components were: titanium (IV) isopropoxide; tantalum (V) ethoxide; niobium (V) ethoxide; hafnium (IV) ethoxide; zirconium (IV) n-propoxide; boric acid; tetraethyl orthosilicate; germanium (IV) isopropoxide; phosphoric acid; lead perchlorate; cerium (III) nitrate; lithium acetate; zinc acetate; and bismuth (III) nitrate.

Although the present invention has been described in connection with the preferred embodiments, it is to be understood that modifications and variations may be utilized without departing from the principles and scope of the invention, as those skilled in the art will readily understand. Accordingly, such modifications may be practiced within the scope of the following claims.

What is claimed is:

1. A method of making a metal oxide material, comprising:
a) producing a sol from a mixture that comprises an epoxide, a precursor to a metal oxide, and a solvent; and
b) preparing a metal oxide material from the sol.

2. The method of claim 1, wherein the precursor is an alkoxide or salt of a transition metal, or is a transition metal ion combined with an inorganic or organic ligand.

3. The method of claim 2, wherein the precursor is titanium isopropoxide, tantalum ethoxide, zirconium n-propoxide, niobium ethoxide, or hafnium ethoxide.

4. The method of claim 1, wherein the mixture further comprises at least one modifier.

5. The method of claim 4, wherein the modifier is an alkoxide or salt of a transition metal, or is a transition metal ion combined with an inorganic or organic ligand, or is a combination thereof.

6. The method of claim 5, wherein the modifier is lead (II) acetate, Ba(ClO₄)₂, Bi(NO₃)₃, or Al(NO₃)₃.

7. The method of claim 1, wherein the mixture further comprises a cosolvent.

8. The method of claim 1, wherein the mixture further comprises water.

9. The method of claim 1, wherein the mixture further comprises a precursor to a glassforming oxide.

10. The method of claim 9, wherein the glassforming oxide precursor is an inorganic glassforming oxide precursor.

11. The method of claim 9, wherein the glassforming oxide precursor is an organic glassforming oxide precursor.

12. The method of claim 9, wherein the glassforming oxide precursor is H₃BO₃, triethyl borate, tetraethyl orthosilicate, H₃PO₄, germanium isopropoxide, H₃AsO₄, AsCl₃, tellurium ethoxide or TeBr₄.

13. The method of claim 9, wherein the glassforming oxide is SiO₂, B₂O₃, P₂O₅, GeO₂, As₂O₃, or TeO₂.

14. The method of claim 9, wherein the metal oxide material comprises: a metal oxide or a mixture of metal and nonmetal oxides comprising a glassy phase; or nano-scale grains of crystalline oxide surrounded by a glassy phase.

15. The method of claim 14, wherein the glassy phase is paraelectric.

16. The method of claim 14, wherein the glassy phase comprises a metal oxide or mixture of metal and nonmetal oxides forming a material having a dielectric constant κ of 10 or greater.

17. The method of claim 14, wherein the glassy phase comprises a metal oxide or mixture of metal and nonmetal oxides forming a material having a dielectric constant κ of 300 or less.

18. The method of claim 1, wherein the metal oxide material has a refractive index n of about 1.45 to about 2.6.

19. The method of claim 1, wherein the metal oxide material is ferroelectric, magnetic or multiferroic.

20. The method of claim 1, wherein the metal oxide material is in the form of a thin layer film, a paste, a monolith, or a fiber.

21. The method of claim 1, wherein preparing comprises drying the sol to produce a film, then baking the film, annealing the film, or both baking and annealing the film.

22. The method of claim 21, wherein annealing involves the use of a laser to heat the film.

23. The method of claim 1, wherein the metal oxide material is prepared by spin-, dip-, roll-, draw-, or spray-coating; or by means of a printing technique; or by casting a monolith; or by drawing fibers.

24. The method of claim 1, wherein the mixture further comprises at least one modifier, a cosolvent, water, or a precursor to a glassforming oxide, or any combination thereof.

25. A sol prepared by the method of claim 1.

26. A sol prepared by the method of claim 24.

27. A dried film produced from the sol of claim 25 by applying the sol to a surface and then drying the applied sol.

28. A film produced from the dried film of claim 27 by baking the dried film to drive off solvent.

29. An annealed film produced from the dried film of claim 27 by annealing the dried film at a temperature from about 250° C. to 800° C.

30. The annealed film of claim 29, wherein the annealed film is amorphous.

31. The annealed film of claim 29, wherein the annealed film is partially crystalline.

32. A metal oxide material produced by the method of claim 1.

33. A metal oxide material produced by the method of claim 24.

34. A metal oxide material comprising a glassforming oxide.

35. The metal oxide material of claim 34 comprising a metal oxide or a mixture of metal and nonmetal oxides comprising a glassy phase; or nano-scale grains of crystalline oxide surrounded by a glassy phase.

36. The metal oxide material of claim 35, wherein the glassy phase is paraelectric.

37. The metal oxide material of claim 34, wherein metal oxide material has a dielectric constant κ of 10 or greater.

38. The metal oxide material of claim 34, wherein metal oxide material has a dielectric constant κ of 300 or less.

39. The metal oxide material of claim 34, wherein the metal oxide material has a refractive index n of about 1.45 to about 2.6.

40. The metal oxide material of claim 34, wherein the metal oxide material is ferroelectric, magnetic or multiferroic.

41. The metal oxide material of 34, wherein the metal oxide material is in the form of a thin layer film, a paste, a monolith, or a fiber.

42. The material of claim 34, wherein the metal oxide material is prepared by spin-, dip-, roll-, draw-, or spray-coating; or by means of a printing technique; or by casting a monolith; or by drawing fibers.
